(19) United States
(12) Patent Application Publication
(10) Pub. No.: US 2024/0331917 A1
(43) Pub. Date: Oct. 3, 2024

(54) MAGNETIC CORE STRUCTURE

(71) Applicant: Delta Electronics (Shanghai) Co.,Ltd., Shanghai (CN)

(72) Inventor: Quanliang ZHANG, Shanghai (CN)

(21) Appl. No.: 18/537,840

(22) Filed: Dec. 13, 2023

(30) Foreign Application Priority Data
Mar. 27, 2023 (CN) 202310315088.5

(51) Int. Cl. H01F 27/255

(52) U.S. Cl. CPC H01F 27/255

(57) ABSTRACT

The disclosure provides a magnetic core structure including at least one magnetic core assembly, wherein the at least one magnetic core assembly includes at least two magnetic blocks spliced with each other, the magnetic core assembly has a cross section along a normal direction of a magnetic flux, and a splicing seam between the at least two magnetic blocks on the cross section is at least partially bent or curved. The magnetic core structure provided in the disclosure reduces eddy-current loss within the magnetic core, and simplifies the assembly process of the magnetic core and the windings.

### CROSS-REFERENCE TO RELATED APPLICATIONS

This non-provisional application claims priority under 35 U.S.C. § 119(a) on patent applications Ser. No. 202310315088.5 filed on Mar. 27, 2023, in P.R. China, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### TECHNOLOGY FIELD

The disclosure relates to the technical field of magnetic integration, and particularly to a magnetic core structure.

### BACKGROUND

As for magnetic elements in the high-frequency switching circuit, loss of the magnetic core is formed of the main loss. In large power applications, loss of the magnetic core is often largely increased due to distribution of eddy currents surrounding a direction of magnetic flux, even exceeding hysteresis loss. Eddy-current loss increases loss of the large power and high frequency magnetic elements, and limits frequency and power, and reduce of this part of loss can effectively enhance efficiency of the magnetic elements, and improve the power density of the magnetic elements.

To sum up, the loss of the magnetic core is formed of the main loss of the magnetic core elements in the high-frequency switching circuit, eddy-current loss increases loss of the large power and high frequency magnetic elements, and limits frequency and power, and reduce of this part of loss is the technical problem to be solved in order to improve efficiency and a power density of the magnetic elements.

### SUMMARY

An object of the disclosure is to provide a magnetic core structure, which reduces eddy-current loss within the magnetic core, and simplifies the assembly process of the magnetic core and the windings.

In order to achieve the object, the disclosure provides a magnetic core structure, including at least one magnetic core assembly, wherein the at least one magnetic core assembly includes at least two magnetic blocks spliced with each other, the magnetic core assembly has a cross section along a normal direction of a magnetic flux, and a splicing seam between the at least two magnetic blocks on the cross section is at least partially bent or curved.

### BRIEF DESCRIPTION OF THE DRAWINGS

In order to clearly explain the technical solution in the embodiments of the disclosure, hereinafter the drawings used in the embodiments are simply introduced, and obviously, the drawings in the below description are only some embodiments of the disclosure. For those of ordinary skill in the art, other accompanying drawings can be obtained according to these accompanying drawings without creative effort.

FIG. 1 is a structural diagram of a magnetic core assembly (spliced by two magnetic blocks) in one embodiment of the disclosure.

FIG. 2 is a structural diagram I of a magnetic core structure in a first embodiment of the disclosure.

FIG. 3 is a structural diagram II of a magnetic core structure in the first embodiment of the disclosure.

FIG. 4 is a structural diagram III of a magnetic core structure in the first embodiment of the disclosure.

FIG. 5 is a structural diagram I of a magnetic core structure in a second embodiment of the disclosure.

FIG. 6 is a structural diagram II of a magnetic core structure in the second embodiment of the disclosure.

FIG. 7 is a structural diagram III of a magnetic core structure in the second embodiment of the disclosure.

FIG. 8 is a structural diagram I of a magnetic core structure in a third embodiment of the disclosure.

FIG. 9 is a structural diagram II of a magnetic core structure in the third embodiment of the disclosure.

FIG. 10 is a structural diagram III of a magnetic core structure in the third embodiment of the disclosure.

### DETAILED DESCRIPTION

Hereinafter the technical solution of the disclosure is described in details combining with the accompanying drawings and the specific embodiments in order to further understand the object, solution and effect of the disclosure, but not as a limit to the scope protected by the appended claims of the disclosure.

Some phrases are used in the specification and subsequent claims to refer to specific component or part, and those of ordinary skill in the art shall understand that users or manufacturers of the technology may name the same component or part with different nouns or terms. The specification and subsequent claims do not use the difference of names as the way of distinguishing the component or part, but using the difference of functions of the component or part as the distinguishing criterion. “Comprise” and “include” mentioned in the whole specification and subsequent claims are open words, so they shall be understood to be “include but not limited to”. Moreover, the word “connect” includes any direct or indirect electrical connection means. Indirect electrical connection means comprises connecting through other devices.

It shall be noted that in the disclosure, orientations or positional relations or parameters indicated by the terms “transverse”, “longitudinal”, “up”, “down”, “front”, “back”, “left”, “right”, “vertical”, “horizontal”, “top”, “bottom”, “in”, “out” and “about”, or “about”, “substantially” and “left and right” are all orientations or positional relations shown in the drawings, and only for convenience of describing the disclosure and simplifying the described contents, instead of indicating or suggesting that the referred device or element must have specific orientation, specific size or constructed and operated in specific orientation, so they also cannot be understood as limit to the disclosure.

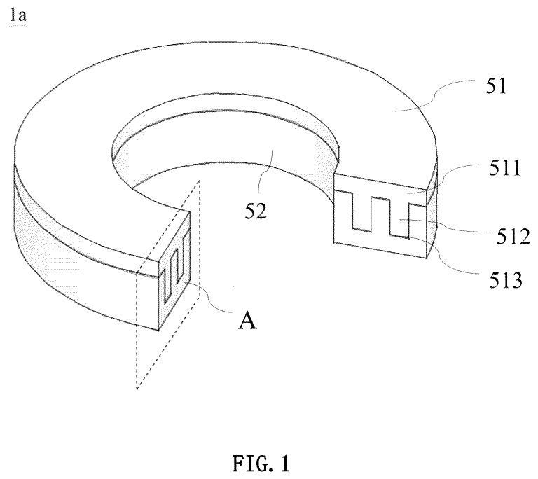

FIG. 1 illustrates a structural diagram of a magnetic core assembly (spliced by two magnetic blocks) in one embodiment of the disclosure. For example, the magnetic core assembly 1a includes a first magnetic block 51 and a second magnetic block 52 spliced with each other, the first magnetic block 51 and the second magnetic block 52 both have a base 511 where a plurality of convex portions 512 are arranged at an interval. In some embodiments, the base can be only provided with one convex portion 512. A concave portion 513 is formed adjacent to the convex portion 512, and when the first magnetic block 51 and the second magnetic block 52 are spliced with each other, the convex portion 512 of the first magnetic block 51 is spliced with the corresponding concave portion 513 of the second magnetic block 52. On a cross section A of the magnetic core assembly 1a along a normal direction of a magnetic flux, the convex portion 512 of the first magnetic block 51 and the corresponding concave portion 513 of the second magnetic block 52 of the magnetic core assembly 1a are formed with a splicing seam 514 on the cross section A, and the splicing seam 514 can be at least partially bent or curved. In some embodiments, shapes of the convex portion 512 and the concave portion 513 are matched with each other.

It should be noted that the normal and tangential directions are perpendicular. In the disclosure, the cross-section along the normal direction of the magnetic flux, such as the cross-section A, is actually perpendicular to the tangential direction (Not shown in the figure) of the magnetic flux.

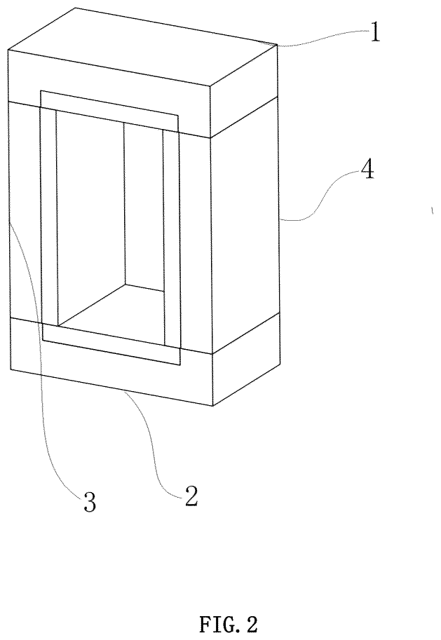

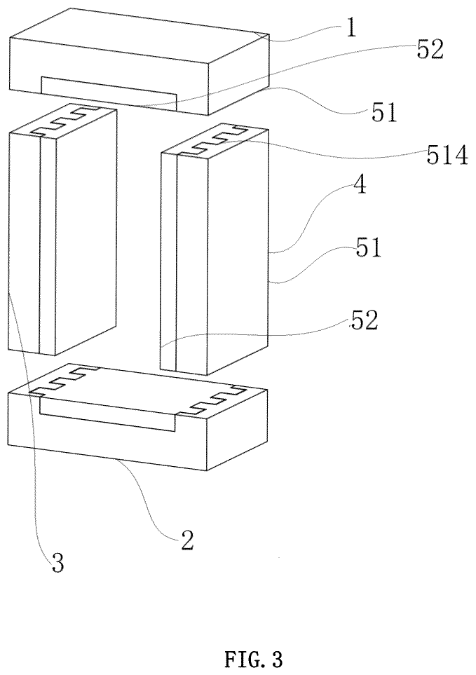

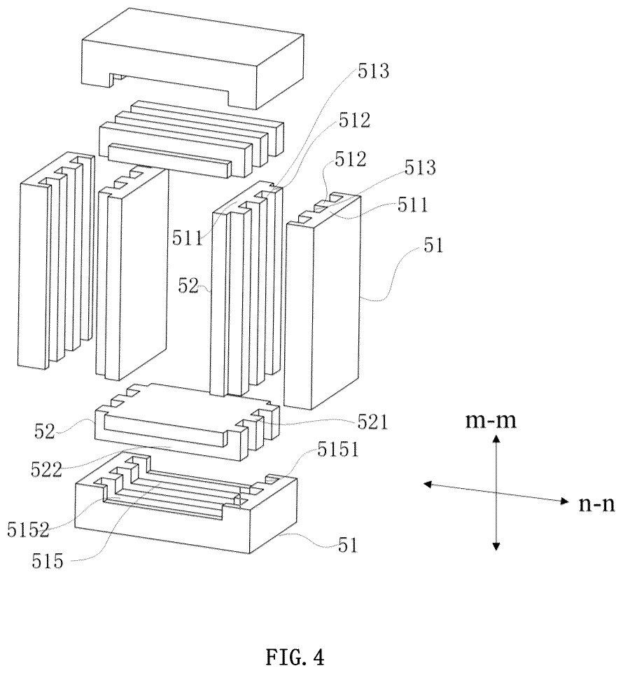

FIGS. 2 to 4 are structural diagrams of a magnetic core structure in a first embodiment of the disclosure. In this embodiment, the magnetic core structure is a ring-shaped magnetic core. In some other embodiments, the magnetic core structure also can be other shape magnetic core, such as, E-shaped, I-shaped or U-shaped, in addition to the ring shape. In this embodiment, it is a ring-shaped magnetic core, and specifically, for example, it can be a mouth shape. In this embodiment, the ring-shaped magnetic core includes a first magnetic core 1, a second magnetic core 2, a third magnetic core 3 and a fourth magnetic core 4, the first magnetic core 1 and the second magnetic core 2 are opposite to each other, the third magnetic core 3 and the fourth magnetic core 4 are opposite to each other, and the first magnetic core 1, the second magnetic core 2, the third magnetic core 3 and the fourth magnetic core 4 are all magnetic core assemblies.

In this embodiment, the magnetic core assemblies of the third magnetic core 3 and the fourth magnetic core 4 include a first magnetic block 51 and a second magnetic block 52, the first magnetic block 51 and the second magnetic block 52 both include a base 511 where a plurality of convex portions 512 are arranged at an interval. In some embodiments, the base can be only provided with one convex portion 512. A concave portion 513 is formed adjacent to the convex portion 512, and when the two magnetic blocks are spliced with each other, the convex portion 512 of the first magnetic block 51 is spliced with the corresponding concave portion 513 of the second magnetic block 52. In this embodiment, shapes of the convex portion 512 and the concave portion 513 are matched with each other, and in order to obviously reduce eddy-current loss of the magnetic core, a height of the at least one convex portion 512 is greater than or equal to a height of the base 511, such that eddy-current paths of the magnetic block can be added to further suppress the eddy-current loss. The assemblies of the first magnetic core 1 and the second magnetic core 2 include the first magnetic block 51 and the second magnetic block 52, the first magnetic block 51 forms a groove 515 along a first direction (such as, a vertical direction) m-m, and the second magnetic block 52 is matched with shape of the groove 515, and arranged within the groove 515, a plurality of first tooth grooves 5151 are formed on a surface inside the groove along a second direction (such as, a horizontal direction) n-n, a plurality of first convex teeth 521 are correspondingly provided on a surface of the second magnetic block 52 along the second direction n-n, and the plurality of first tooth grooves 5151 and the plurality of first convex teeth 521 are spliced with each other. Further, in this embodiment, the plurality of first convex teeth 521 and a surface facing the first magnetic block 51 of the second magnetic block 52 extend along the first direction m-m to form a plurality of second convex teeth 522, a plurality of second tooth grooves 5152 are correspondingly provided on a surface of the groove 515 of the first magnetic block 51 along the first direction m-m, and the plurality of second convex teeth 522 and the plurality of second tooth grooves 5152 are spliced with each other. In some embodiments, shapes of the first tooth grooves 5151 and the first convex teeth 521 are matched with each other, and shapes of the second convex teeth 522 and the second tooth grooves 5152 are matched with each other.

It shall be noted that in this embodiment, the magnetic core assembly has a cross section along a normal direction of a magnetic flux, and a splicing seam 514 formed on the cross section where the convex portion 512 of the first magnetic block 51 is spliced with the corresponding concave portion 513 of the second magnetic block 52 of the magnetic core assembly can be at least partially bent or curved. Meanwhile, it shall be noted that in this embodiment, the first magnetic core 1, the second magnetic core 2, the third magnetic core 3 and the fourth magnetic core 4 are all magnetic core assemblies. In some embodiments, at least one of the first magnetic core 1, the second magnetic core 2, the third magnetic core 3 and the fourth magnetic core 4 is the magnetic core assembly. In the magnetic core structure disclosed in this embodiment, when the first magnetic core 1, the second magnetic core 2, the third magnetic core 3 and the fourth magnetic core 4 are all the magnetic core assemblies, and when the first magnetic core 1 is spliced with the third magnetic core 3 and the fourth magnetic core 4, or the second magnetic core 2 is spliced with the third magnetic core 3 and the fourth magnetic core 4, splicing seams 514 between the two spliced magnetic cores are aligned with each other. In some embodiments, shapes of the convex portion 512 and the concave portion 513 are matched with each other.

The assembled magnetic core structure provided in this embodiment can introduce an air gap between the magnetic core assemblies to regulate a magnetic resistance of the magnetic core, and can be assembled with the windings more conveniently.

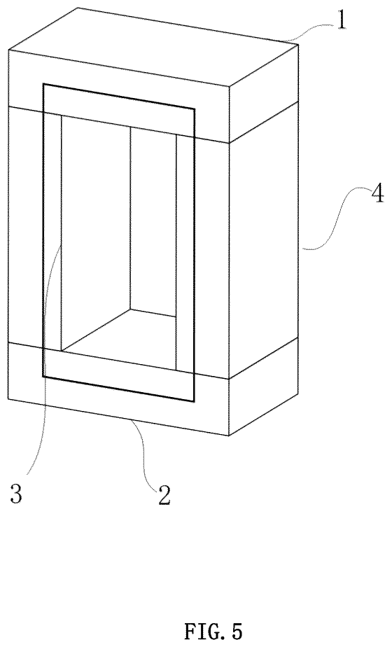

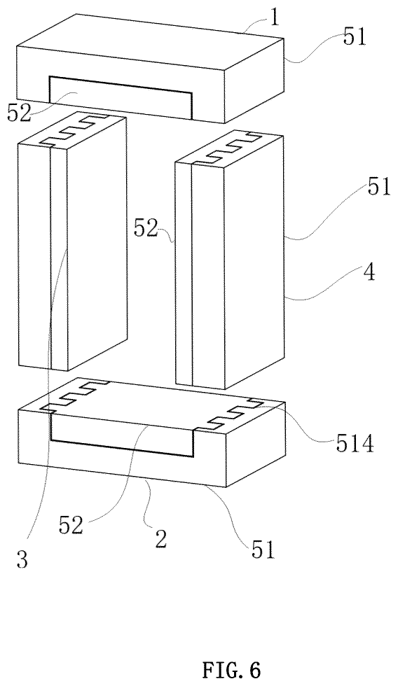

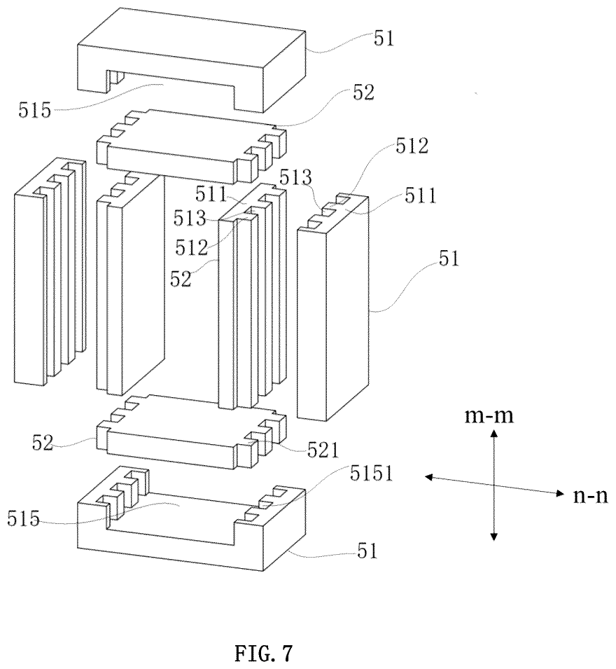

FIGS. 5 to 7 are schematic diagrams of a magnetic core structure in a second embodiment of the disclosure, and the magnetic core structure disclosed in this embodiment is similar with that in the first preferable embodiment. In this embodiment, the magnetic core structure is a ring-shaped magnetic core. In some other embodiments, the magnetic core structure also can be other shape magnetic core, such as, E-shaped, I-shaped or U-shaped, in addition to the ring shape. In this embodiment, it is a ring-shaped magnetic core, and specifically, for example, it can be a mouth shape. In this embodiment, the ring-shaped magnetic core includes a first magnetic core 1, a second magnetic core 2, a third magnetic core 3 and a fourth magnetic core 4, the first magnetic core 1 and the second magnetic core 2 are opposite to each other, and the third magnetic core 3 and the fourth magnetic core 4 are opposite to each other. This embodiment simplifies structures of the first magnetic core 1 and the second magnetic core 2, and reduces complexity of mold of the magnetic core. The first magnetic core 1 or the second magnetic core 2 is the magnetic core assembly including a first magnetic block 51 and a second magnetic block 52, the assemblies of the first magnetic core 1 and the second magnetic core 2 include the first magnetic block 51 and the second magnetic block 52, the first magnetic block 51 forms a groove 515 along a first direction (such as, a vertical direction) m-m, and the second magnetic block 52 is matched with shape of the groove 515, and arranged within the groove 515, a plurality of first tooth grooves 5151 are formed on a surface inside the groove along a second direction (such as, a horizontal direction) n-n, a plurality of first convex teeth 521 are correspondingly provided on a surface of the second magnetic block 52 along the second direction n-n, and the plurality of first tooth grooves 5151 and the plurality of first convex teeth 521 are spliced with each other. In this embodiment, the third magnetic core 3 and the fourth magnetic core 4 are magnetic core assemblies, the magnetic core assemblies include a first magnetic block 51 and a second magnetic block 52, the first magnetic block 51 and the second magnetic block 52 both include a base 511 where a plurality of convex portions 512 are arranged at an interval, a concave portion 513 is formed between the adjacent two convex portions 512, and when the two magnetic blocks are spliced with each other, the convex portion 512 of the first magnetic block 51 is spliced with the corresponding concave portion 513 of the second magnetic block 52. In some embodiments, shapes of the convex portion 512 and the concave portion 513 are matched with each other.

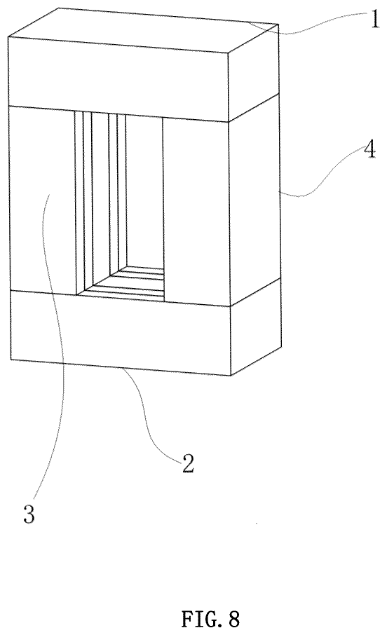

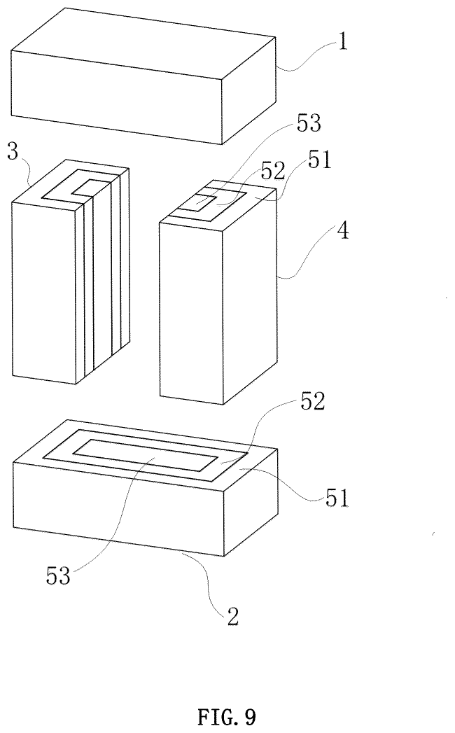

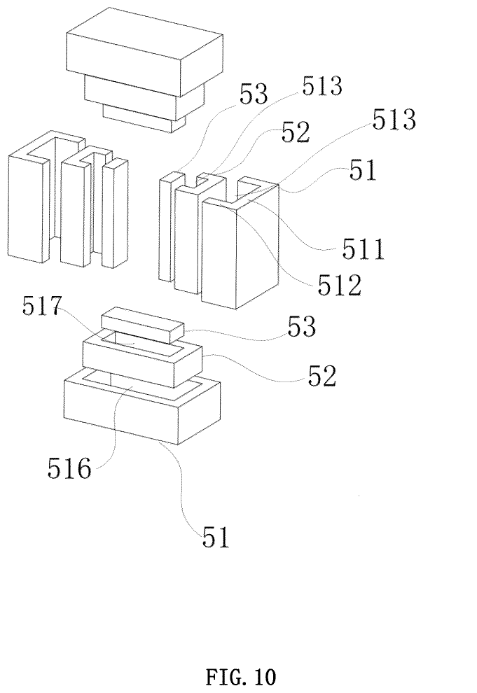

FIGS. 8 to 10 are schematic diagrams of a magnetic core structure in a third embodiment of the disclosure. In this embodiment, the magnetic core structure is a ring-shaped magnetic core. In some other embodiments, the magnetic core structure also can be other shape magnetic core, such as, E-shaped, I-shaped or U-shaped, in addition to the ring shape. In this embodiment, it is a ring-shaped magnetic core, and specifically, for example, it can be a mouth shape. In this embodiment, the ring-shaped magnetic core includes a first magnetic core 1, a second magnetic core 2, a third magnetic core 3 and a fourth magnetic core 4, the first magnetic core 1 and the second magnetic core 2 are opposite to each other, the third magnetic core 3 and the fourth magnetic core 4 are opposite to each other, and the first magnetic core 1, the second magnetic core 2, the third magnetic core 3 and the fourth magnetic core 4 are all magnetic core assemblies.

In this embodiment, the first magnetic core 1 and the second magnetic core 2 are magnetic core assemblies including a first magnetic block 51, a second magnetic block 52 and a third magnetic block 53, the first magnetic block 51 includes a first annular groove 516, the second magnetic block 52 includes a second annular groove 517, the third magnetic block 53 is an integral magnetic block, and when the three magnetic blocks are spliced with each other, the third magnetic block 53 is arranged within the second annular groove 517, the second magnetic block 52 is arranged within the first annular groove 516. The third magnetic block 53 is matched with shape of the second annular groove 517, and the second magnetic block 52 is matched with shape of the first annular groove 516. In this embodiment, the third magnetic core 3 and the fourth magnetic core 4 are magnetic core assemblies including a first magnetic block 51, a second magnetic block 52 and a third magnetic block 53, the first magnetic block 51 and the second magnetic block 52 both include a base 511 provided with two convex portions 512 opposite to each other on both sides, a concave portion 513 is formed between the two convex portions 512, the third magnetic block 53 is an integral magnetic block, and when the three magnetic blocks are spliced with each other, the base 511 of the second magnetic block 52 and the outer sides of the two convex portions 512 of the second magnetic block 52 are spliced with the concave portion 513 of the first magnetic block 51, and the third magnetic block 53 is spliced with the concave portion 513 of the second magnetic block 52. The base 511 of the second magnetic block 52 and the outer sides of the two convex portions 512 of the second magnetic block 52 are matched with shapes of the concave portion 513 of the first magnetic block 51, and the third magnetic block 53 is matched with shape of the concave portion 513 of the second magnetic block 52.

In the magnetic core structure provided in this embodiment, the magnetic block can have a simpler combination structure, and is easily manufactured for mold forming.

It shall be noted that in this embodiment, the first magnetic core 1, the second magnetic core 2, the third magnetic core 3 and the fourth magnetic core 4 are all magnetic core assemblies. In some embodiments, and at least one of the first magnetic core 1, the second magnetic core 2, the third magnetic core 3 and the fourth magnetic core 4 is the magnetic core assembly. In the magnetic core structure disclosed in this embodiment, when the first magnetic core 1, the second magnetic core 2, the third magnetic core 3 and the fourth magnetic core 4 are all the magnetic core assemblies, and when the first magnetic core 1 is spliced with the third magnetic core 3 and the fourth magnetic core 4, or the second magnetic core 2 is spliced with the third magnetic core 3 and the fourth magnetic core 4, splicing seams between the two spliced magnetic cores are aligned with each other.

In another embodiment of the disclosure, any cross section of the magnetic core assembly along the normal direction of the magnetic flux has a convex polygon, and the convex polygon includes a magnetic material and an insulating material inside. In some other embodiments, the convex polygon only includes a magnetic material and an insulating material inside.

It shall be noticed that when a plurality of magnetic core assemblies are provided in the embodiments of the disclosure, and the assemblies shall be directly engaged to form a complete magnetic core, in order to prevent large eddy-current loss produced in the magnetic material on both sides of the assembled surface, the splicing seams on both sides of the assembled surface of the assembly can have a consistent shape.

The splicing seam 514 provided in the embodiments of the disclosure can be a folding or arc shape, and an outer surface of the magnetic core assembly is at least partially formed by splicing of the two magnetic blocks. Further, the magnetic core assembly is an I-shaped, U-shaped or E-shaped magnetic core, and in this embodiment, the magnetic core is made of ferrite or powder core material. It is possible to firstly form the magnetic core, and then assemble, and it is also possible to directly pressed forming the sheet insulating material and the magnetic material.

In addition, the magnetic core structure in the embodiment of the disclosure can be applied to a transformer with two windings. The windings can be arranged on the same magnetic column (For example, the first magnetic core 1, the second magnetic core 2, the third magnetic core 3 or the fourth magnetic core 4 in the embodiments of the disclosure) inside and outside or arranged on the same magnetic column alternatively, and the two windings also can be arranged on different magnetic columns. The magnetic core structure in the embodiments of the disclosure also can be applied to an inductor with one winding, and the winding can be arranged on any magnetic column.

The magnetic core structure provided in the disclosure includes at least one magnetic core assembly, wherein the at least one magnetic core assembly includes at least two magnetic blocks spliced with each other, the magnetic core assembly has a cross section along a normal direction of a magnetic flux, and a splicing seam between the at least two magnetic blocks on the cross section is at least partially bent or curved, which can reduce the maximum induced electromotive force of the magnetic blocks, and suppress eddy currents.

The outer surface of the magnetic core in the magnetic core structure provided in the disclosure is at least partially formed by splicing of the two magnetic blocks, which can add eddy-current paths in the magnetic blocks, and suppress eddy currents.

Meanwhile, the magnetic core structure provided in the disclosure has a convex polygon on any cross section of the magnetic core along the normal direction of the magnetic flux, and the convex polygon surrounds all magnetic materials and only includes a magnetic material and an insulating material inside, which can avoid space waste while avoiding the eddy-current loss, and largely reduce loss of the turbine in the magnetic core.

To sum up, the disclosures are only preferable embodiments of the disclosure, not limiting the disclosure in other forms, and any skilled in the art can change or modify the disclosed technical contents to be equivalent embodiments with equivalent changes, and apply them to other fields, but any simple alternations, equivalent changes and modifications to the above embodiments based on the technical essence of the disclosure without departing from the technical solution of the disclosure still belong to the scope protected by the technical solution of the disclosure.

What is claimed is:

1. A magnetic core structure, comprising at least one magnetic core assembly, wherein the at least one magnetic core assembly comprises at least two magnetic blocks spliced with each other, the magnetic core assembly has a cross section along a normal direction of a magnetic flux, and a splicing seam between the at least two magnetic blocks on the cross section is at least partially bent or curved.

2. The magnetic core structure according to claim 1, wherein the magnetic block comprises a base provided with a convex portion, a concave portion is formed adjacent to the convex portion, and when the at least two magnetic blocks are spliced with each other, the convex portion of one magnetic block is spliced with the corresponding concave portion of the other magnetic block.

3. The magnetic core structure according to claim 1, wherein the magnetic core structure is a ring-shaped magnetic core.

4. The magnetic core structure according to claim 3, wherein the ring-shaped magnetic core comprises a first magnetic core, a second magnetic core, a third magnetic core and a fourth magnetic core, the first magnetic core and the second magnetic core are opposite to each other, the third magnetic core and the fourth magnetic core are opposite to each other, and at least one of the first magnetic core, the second magnetic core, the third magnetic core and the fourth magnetic core is the magnetic core assembly.

5. The magnetic core structure according to claim 4, wherein the at least one magnetic core assembly comprises a first magnetic block and a second magnetic block, the first magnetic block and the second magnetic block both comprise a base provided with a convex portion, a concave portion is formed adjacent to the convex portion, and when the two magnetic blocks are spliced with each other, the convex portion of the first magnetic block is spliced with the corresponding concave portion of the second magnetic block.

6. The magnetic core structure according to claim 4, wherein the at least one magnetic core assembly comprises a first magnetic block and a second magnetic block, the first magnetic block forms a groove along a first direction, and the second magnetic block is matched with shape of the groove, and arranged within the groove.

7. The magnetic core structure according to claim 6, wherein a plurality of first tooth grooves are formed on a surface inside the groove along a second direction, a plurality of first convex teeth are correspondingly provided on a surface of the second magnetic block along the second direction, and the plurality of first tooth grooves and the plurality of first convex teeth are spliced with each other.

8. The magnetic core structure according to claim 7, wherein the plurality of first convex teeth and a surface facing the first magnetic block of the second magnetic block extend along the first direction to form a plurality of second convex teeth, a plurality of second tooth grooves are correspondingly provided on a surface of the groove of the first magnetic block along the first direction, and the plurality of second convex teeth and the plurality of second tooth grooves are spliced with each other.

9. The magnetic core structure according to claim 2, wherein a height of the at least one convex portion is greater than or equal to a height of the base.

10. The magnetic core structure according to claim 2, wherein shapes of the convex portion and the concave portion are matched with each other.

11. The magnetic core structure according to claim 4, wherein the at least one magnetic core assembly comprises a first magnetic block, a second magnetic block and a third magnetic block, the first magnetic block and the second magnetic block both comprise a base provided with two convex portions opposite to each other on both sides, a concave portion is formed between the two convex portions, the third magnetic block is an integral magnetic block, and when the three magnetic blocks are spliced with each other, the base of the second magnetic block and the outer sides of the two convex portions of the second magnetic block are spliced with the concave portion of the first magnetic block, and the third magnetic block is spliced with the concave portion of the second magnetic block.

12. The magnetic core structure according to claim 11, wherein the base of the second magnetic block and the outer sides of the two convex portions of the second magnetic block are matched with shapes of the concave portion of the first magnetic block, and the third magnetic block is matched with shape of the concave portion of the second magnetic block.

13. The magnetic core structure according to claim 4, wherein the at least one magnetic core assembly comprises a first magnetic block, a second magnetic block and a third magnetic block, the first magnetic block comprises a first annular groove, the second magnetic block comprises a second annular groove, the third magnetic block is an integral magnetic block, and when the three magnetic blocks are spliced with each other, the third magnetic block is arranged within the second annular groove, and the second magnetic block is arranged within the first annular groove.

14. The magnetic core structure according to claim 13, wherein the third magnetic block is matched with shape of the second annular groove, and the second magnetic block is matched with shape of the first annular groove.

15. The magnetic core structure according to claim 4, wherein the first magnetic core, the second magnetic core, the third magnetic core and the fourth magnetic core are the magnetic core assemblies, and when the first magnetic core is spliced with the third magnetic core and the fourth magnetic core, or the second magnetic core is spliced with the third magnetic core and the fourth magnetic core, splicing seams of the two spliced magnetic cores are aligned with each other.

16. The magnetic core structure according to claim 1, wherein any cross section of the magnetic core assembly along the normal direction of the magnetic flux has a convex polygon, and the convex polygon only comprises magnetic material and insulating material inside.

17. The magnetic core structure according to claim 1, wherein an outer surface of the magnetic core assembly is at least partially formed by splicing two magnetic blocks.

18. The magnetic core structure according to claim 1, wherein the splicing seam is a folding or arc shape.

19. The magnetic core structure according to claim 1, wherein the magnetic core assembly is an I-shaped, U-shaped or E-shaped magnetic core.

20. The magnetic core structure according to claim 1, wherein the magnetic core is made of ferrite or powder core material.
